(19) United States
(12) Patent Application Publication
(10) Pub. No.: US 2024/0296982 A1
(43) Pub. Date: Sep. 5, 2024

(54) BOBBIN FOR SLIM MAGNETIC COMPONENT

(71) Applicants: LG INNOTEK CO., LTD., Seoul (KR); AMOGREENTECH CO., LTD., Gyeonggi-do (KR)

(72) Inventors: Jung Eun LEE, Seoul (KR); In Seong SOHN, Seoul (KR); Young Hwan JUNG, Seoul (KR); Sang II KIL, Gyeonggi-do (KR); Ki Young KIM, Gyeonggi-do (KR)

(21) Appl. No.: 18/570,747

(22) PCT Filed: Jun. 17, 2022
(86) PCT No.: PCT/KR2022/008628

§ 371 Date: Dec. 15, 2023

(30) Foreign Application Priority Data
Jun. 17, 2021 (KR) 10-2021-0078593

(51) Int. Cl. H01F 5/06; H01F 5/04

(52) U.S. Cl. CPC H01F 5/06; H01F 5/04

(57) ABSTRACT

The present invention relates to a bobbin that can be used for a slim magnetic component. A bobbin for a magnetic part, according to one embodiment of the present invention, comprises: a first bobbin which has a space for accommodating a magnetic core therein, and which includes a pair of isolation protrusions disposed to be opposite to each other, so as to separate a first region and a second region; and a second bobbin including a coil-loading groove in which a first coil and a second coil are loaded while wound around the first bobbin, and terminals formed on the outside of the coil-loading groove in respective quadrant regions with respect to the coil-loading groove.

### TECHNICAL FIELD

The present disclosure relates to a bobbin usable for slim magnetic components.

### BACKGROUND ART

As slimness of products, for example, TVs, accelerates, there is a large demand for slim magnetic components. According to such a demand, in order to reduce a mounting area and to secure price competitiveness, components have currently become miniaturized. Illustratively, FIG. 1 shows a conventional EMI filter, which includes a first [3] bobbin formed in a cylindrical donut shape and accommodating a magnetic substance therein, first and second coils wound on both sides of the first bobbin with respect to the center portion of the first bobbin, and a second bobbin provided separately from the first bobbin and including a coil-seating recess formed in the center thereof to allow the first and second coils to be received therein in a state of being wound on the first bobbin and extension portions extending from two opposite points of the coil-seating recess and having a plurality of terminals mounted thereto.

Such a conventional EMI filter has the following problems because the terminals are gathered on two opposite sides thereof.
1) It is difficult to secure a sufficient terminal area due to spatial limitations, and accordingly, when the size of the terminal increases, the overall size of the component increases.
2) There is a limitation on miniaturization because the component inevitably has a relatively long length w1 in one direction.

### DISCLOSURE

### Technical Problem

An object of the present disclosure is to solve at least one of the above problems with the related art.

That is, an object of the present disclosure is to provide a bobbin suitable for a miniaturized structure.

### Technical Solution

A bobbin for magnetic components according to an embodiment of the present disclosure includes a first bobbin including a space defined therein to accommodate a magnetic core and a pair of isolation protrusions disposed opposite each other so as to divide the first bobbin into a first section and a second section and a second bobbin including a coil-seating recess formed therein to allow a first coil and a second coil to be seated therein in a state of being wound on the first bobbin and terminals disposed outside the coil-seating recess in regions corresponding to four quadrants of the coil-seating recess.

In at least one embodiment of the present disclosure, the second bobbin includes a pair of extension portions extending from two opposite sides of the coil-seating recess in a direction of a virtual straight line connecting the pair of isolation protrusions, and the central portions of the extension portions corresponding to the isolation protrusions are formed such that a distance from the coil-seating recess to an outermost portion of each of the extension portions in the direction of the virtual straight line is shorter than the length of each of the terminals in the direction of the virtual straight line.

In addition, in at least one embodiment of the present disclosure, the length of at least a part of each of the extension portions in the direction of the virtual straight line is longer than the length of each of the terminals.

In at least one embodiment of the present disclosure, the extension portions include second isolation protrusions formed on the central portions thereof.

In at least one embodiment of the present disclosure, the second bobbin is formed to be at least partially convex in an outward direction along the shape of the coil-seating recess.

In at least one embodiment of the present disclosure, the terminals are mounted on four corners of the second bobbin.

In at least one embodiment of the present disclosure, the terminals are mounted on the second bobbin so as to cover an upper surface, a lower surface, and side surfaces between the upper surface and the lower surface of the second bobbin.

### Advantageous Effects

According to the present disclosure, a bobbin suitable for miniaturized magnetic components may be obtained.

Additional effects of the present disclosure will be apparently understood by those skilled in the art from the following description of embodiments of the present disclosure.

### DESCRIPTION OF DRAWINGS

FIG. 1 illustrates an EMI filter as a conventional magnetic component.

FIG. 2 illustrates an embodiment of the present disclosure.

FIG. 3 illustrates a first bobbin shown in FIG. 2.

FIG. 4 illustrates a second bobbin shown in FIG. 2.

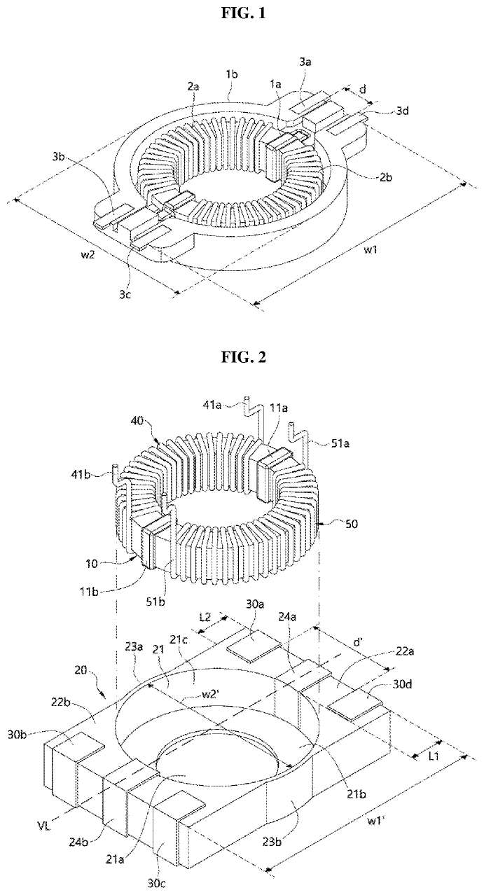

### DESCRIPTION OF REFERENCE NUMERALS

10: first bobbin 11: isolation protrusion
20: second bobbin 21: coil-seating recess
22: extension portion 23: convex portion
24: second isolation protrusion
30: terminal 40: first coil
41: (first coil) wire terminal 50: second coil
51: (second coil) wire terminal

### BEST MODE

The present disclosure may make various changes and have various embodiments, and specific embodiments are illustrated and described in the drawings. However, this is not intended to limit the present disclosure to a specific embodiment, and should be understood to include all changes, equivalents, or substitutes included in the spirit and technical scope of the present disclosure.

The suffixes “module” and “unit” used in this specification are only used for denominative distinction between elements, and should not be construed as presuming that the terms are physically and chemically distinguished or separated or may be distinguished or separated in that way.

Although terms including ordinal numbers, such as “first”, “second”, etc., may be used herein to describe various elements, the elements are not limited by these terms. These terms are only used to distinguish one element from another.

The term “and/or” is used to include any combination of a plurality of items that are the subject matter. For example, “A and/or B” inclusively means all three cases such as “A”, “B”, and “A and B”.

It will be understood that when a component is referred to as being “connected to” or “coupled to” another component, it may be directly connected to or coupled to another component, or intervening components may be present.

In the description of the embodiments, it will be understood that when an element, such as a layer (film), a region, a pattern or a structure, is referred to as being “on” or “under” another element, such as a substrate, a layer (film), a region, a pad or a pattern, the term “on” or “under” means that the element is directly on or under another element or is formed such that an intervening element may also be present. In addition, it will also be understood that criteria of “on” or “under” is on the basis of the drawing for convenience unless otherwise defined due to the characteristics of each of components or the relationship therebetween. The term “on” or “under” is used only to indicate the relative positional relationship between components and should not be construed as limiting the actual positions of the components. For example, the phrase “B on A” merely indicates that B is illustrated in the drawing as being located on A, unless otherwise defined or unless A must be located on B due to the characteristics of A or B. In an actual product, B may be located under A, or B and A may be disposed in a leftward-rightward direction.

In addition, the thickness or size of a layer (film), a region, a pattern, or a structure shown in the drawings may be exaggerated, omitted, or schematically drawn for the clarity and convenience of explanation, and may not accurately reflect the actual size.

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the terms “include” or “have”, when used herein, specify the presence of stated features, integers, steps, operations, elements, components, or combinations thereof, but do not preclude the presence or addition of one or more other features, integers, steps, operations, elements, components, or combinations thereof.

Unless defined otherwise, all terms used herein, including technical or scientific terms, have the same meanings as commonly understood by one of ordinary skill in the art to which the present disclosure belongs. Terms such as those defined in commonly used dictionaries should be interpreted as having meanings consistent with the meanings in the context of the related art, and unless explicitly defined in this application, the terms should not be interpreted as having ideal or excessively formal meanings.

FIG. 2 illustrates an embodiment of the present disclosure.

For better understanding, both a first coil 40 and a second coil 50 are shown in FIG. 2.

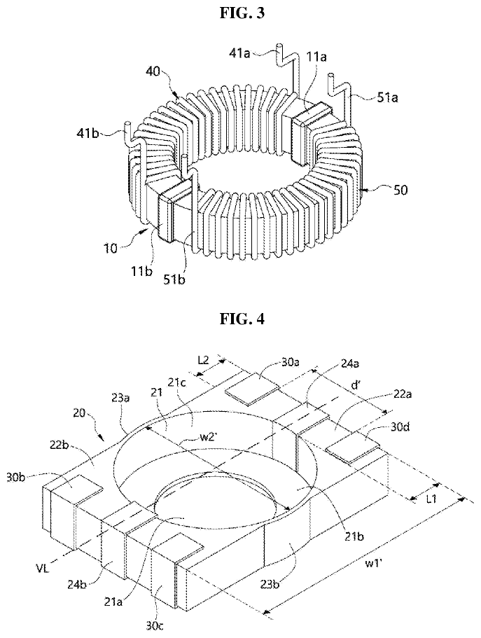

FIG. 3 is an enlarged view of a first bobbin 10 on which the first coil 40 and the second coil 50 shown in FIG. 2 are wound, and FIG. 4 is an enlarged view of a second bobbin 20.

The first bobbin 10 is provided separately from the second bobbin 20, and includes a space defined therein to accommodate a magnetic core (not shown).

The first bobbin 10 has a substantially circular donut shape, and is provided in the substantially middle thereof with a pair of isolation protrusions 11a and 11b.

The first bobbin 10 is divided into a first section (a section on which a first coil to be described later is wound) and a second section (a section on which a second coil to be described later is wound) by the pair of isolation protrusions 11a and 11b, and the two sections are isolated from each other by the isolation protrusions 11a and 11b from a viewpoint of winding of the first coil 40 and the second coil 50.

The first bobbin 10 may include a lower part having a U-shaped cross-section and an upper part having an inverted U-shaped cross-section, and may have a structure in which the upper part and the lower part overlap each other to be coupled to each other in a state of accommodating magnetic cores therein.

A first coil 40 is wound on the first section, which is one section of the first bobbin 10, and a second coil 50 is wound on the second section of the first bobbin 10.

The second bobbin 20 includes a coil-seating recess 21 formed in the center thereof, and the first coil 40 and the second coil 50 are seated in the coil-seating recess 21 in a state of being wound on the first bobbin 10.

The coil-seating recess 21 has a structure in which a through-hole 21a is formed in the center thereof, a seating portion 21b extends from the circumferential edge of the through-hole in a radially outward direction, and a peripheral wall 21c is formed to a predetermined height from the outer circumference of the seating portion 21b.

In addition, the second bobbin 20 includes a first extension portion 22a and a second extension portion 22b, which extend from two opposite sides of the coil-seating recess 21 in a direction of a virtual straight line VL connecting the pair of isolation protrusions 11a and 11b of the first bobbin 10.

Terminals 30a, 30b, 30c, and 30d are mounted at four points in the two extension portions 22a and 22b. As shown in FIG. 2, the terminals 30a, 30b, 30c, and 30d are mounted outside the coil-seating recess 21 so as to be disposed in regions corresponding to four quadrants of the coil-seating recess 21. That is, a first terminal 30a is mounted in a region corresponding to a first quadrant, a second terminal 30b is mounted in a region corresponding to a second quadrant, a third terminal 30c is mounted in a region corresponding to a third quadrant, and a fourth terminal 30d is mounted in a region corresponding to a fourth quadrant. In this embodiment, the terminals 30a, 30b, 30c, and 30d are mounted on four corners of the second bobbin 20.

The central portions of the extension portions 22a and 22b corresponding to the isolation protrusions 11a and 11b may be formed such that a distance L1 from the coil-seating recess 21 to the outermost portion of each of the extension portions 22a and 22b is short, and the terminals 30a, 30b, 30c, and 30d may be disposed sufficiently far from the central portions of the extension portions 22a and 22b, whereby there are no spatial limitations on mounting of the terminals 30a, 30b, 30c, and 30d, and the upper surfaces or lower surfaces (mounted surfaces) of the terminals 30a, 30b, 30c, and 30d may be increased in area.

That is, the distance L1 may be shorter than a length L2 of the terminal in the direction of the virtual straight line VL, and the terminals 30a, 30b, 30c, and 30d may be mounted on regions of the extension portions 22a and 22b that have a sufficient length in the direction of the virtual straight line VL. Accordingly, the overall length w1′ of the EMI filter in the direction of the virtual straight line VL may be reduced.

In addition, the extension portions 22a and 22b include second isolation protrusions 24a and 24b formed on the central portions thereof, whereby wire terminals 41a and 41b of the first coil 40 and wire terminals 51a and 51b of the second coil 50 may be more reliably isolated from each other.

In addition, among the wire terminals 41a and 41b of the first coil 40 and the wire terminals 51a and 51b of the second coil 50, a pair of wire terminals 41a and 51a disposed opposite each other with respect to the virtual straight line VL and a pair of wire terminals 41b and 51b disposed opposite each other with respect to the virtual straight line VL extend outside the coil-seating recess 21 to be connected to the terminals 30a, 30b, 30c, and 30d, respectively.

Each of the terminals 30a, 30b, 30c, and 30d is mounted so as to cover the upper, lower, and side surfaces of the second bobbin 20 while penetrating the second bobbin 20.

Meanwhile, the second bobbin 20 includes convex portions 23a and 23b formed convexly in an outward direction along the shape of the coil-seating recess 21 on at least portions of outer side surfaces thereof that are formed opposite each other with respect to the virtual straight line VL.

The EMI filter of this embodiment may be miniaturized such that the overall length w2′ thereof in a direction perpendicular to the virtual straight line VL is not longer than that in the conventional structure and the overall length w1′ thereof in the direction of the virtual straight line VL is shorter than that in the conventional structure.

1. A bobbin for magnetic components, the bobbin comprising:
a first bobbin including a space defined therein to accommodate a magnetic core and a pair of isolation protrusions disposed opposite each other so as to divide the first bobbin into a first section and a second section; and
a second bobbin including a coil-seating recess formed therein to allow a first coil and a second coil to be seated therein in a state of being wound on the first bobbin and terminals disposed outside the coil-seating recess in regions corresponding to four quadrants of the coil-seating recess.

2. The bobbin according to claim 1, wherein the second bobbin includes a pair of extension portions extending from two opposite sides of the coil-seating recess in a direction of a virtual straight line connecting the pair of isolation protrusions, and
wherein central portions of the extension portions corresponding to the pair of isolation protrusions are formed such that a distance from the coil-seating recess to an outermost portion of each of the extension portions in the direction of the virtual straight line is shorter than a length of each of the terminals in the direction of the virtual straight line.

3. The bobbin according to claim 2, wherein a length of at least a part of each of the extension portions in the direction of the virtual straight line is longer than the length of each of the terminals.

4. The bobbin according to claim 2, wherein the extension portions include second isolation protrusions formed on the central portions thereof.

5. The bobbin according to claim 1, wherein the second bobbin is formed to be at least partially convex in an outward direction along a shape of the coil-seating recess.

6. The bobbin according to claim 1, wherein the terminals are mounted on four corners of the second bobbin.

7. The bobbin according to claim 1, wherein the terminals are mounted on the second bobbin so as to surround an upper surface, a lower surface, and side surfaces between the upper surface and the lower surface of the second bobbin.

8. The bobbin according to claim 1, wherein the first coil is wound on the first section, and the second coil is wound on the second section.

9. The bobbin according to claim 1, wherein the bobbin comprises:
a lower part having a U-shaped cross-section; and
an upper part having an inverted U-shaped cross-section.

10. The bobbin according to claim 9, wherein the upper part and the lower part overlap each other to be coupled to each other.

11. The bobbin according to claim 2, wherein first wire terminals of the first coil and second wire terminals of the second coil are disposed opposite each other with respect to the virtual straight line.

12. The bobbin according to claim 11, wherein the first and second wire terminals are disposed to extend outside the coil-seating recess.

13. The bobbin according to claim 12, wherein the first and second wire terminals are connected to the terminals.

14. The bobbin according to claim 2, wherein the second bobbin includes convex portions formed convexly in an outward direction along a shape of the coil-seating recess on at least portions of outer side surfaces thereof that are formed opposite each other with respect to the virtual straight line.

15. The bobbin according to claim 7, wherein each of the terminals penetrates the second bobbin.

16. A bobbin for magnetic components, the bobbin comprising:
a first bobbin accommodating a magnetic core; and
a second bobbin including a coil-seating recess, and terminals disposed outside the coil-seating recess,
wherein the first bobbin comprises:
a first section on which a first coil having first wire terminals is wound;
a second section on which a second coil having second wire terminals is wound; and
a pair of isolation protrusions disposed between the first section and the second section.

17. The bobbin according to claim 16, wherein the terminals include first and fourth terminals disposed in regions corresponding to four quadrants of the coil-seating recess.

18. The bobbin according to claim 16, wherein the second bobbin further comprises extension portions defining the coil-seating recess, the terminals being disposed at surroundings of the coil-seating recess in the extension portions.

19. The bobbin according to claim 18, wherein the first and second terminals are connected to the terminals.

20. An EMI filter comprising the bobbin according to claim 1.
